(19) United States
(12) Patent Application Publication
(10) Pub. No.: US 2012/0060325 A1
(43) Pub. Date: Mar. 15, 2012

(54) Hinge

(76) Inventor: Chao-Chi Lin, Taichung (TW)

(21) Appl. No.: 12/943,059

(22) Filed: Nov. 10, 2010

(30) Foreign Application Priority Data
Sep. 13, 2010 (TW) 99217708

(51) Int. Cl. E05D 11/08; E05D 11/10

(52) U.S. Cl. 16/327; 16/341

(57) ABSTRACT

A hinge includes a fixing frame, a cam, a rotating frame, and a torque assembly. The fixing frame includes a compartment and an orifice. The cam is insertably mounted to the fixing frame through the orifice. Furthermore, the cam includes a cam member disposed in the compartment. The rotating frame is joined to the cam and rotated with the cam concurrently. The torque assembly is disposed in the compartment and is moveably urged relative to the fixing frame by the cam. Furthermore, the torque assembly includes an end abutted against the cam member and another end supported by the fixing frame. Moreover, the torque assembly imposes torque that is variable during the pivoting of the rotating frame with respect to the fixing frame.

### BACKGROUND OF THE INVENTION

1. Field of the Invention

The present invention relates to a hinge, and particularly, to a hinge that is usable in an electronic device and is capable of generating torque that is variable and, so the hinge makes a cover of the electronic device experience different amount of torque throughout the opening/closing operation thereof.

2. Description of the Related Art

Ordinarily, a conventional hinge for an electronic device includes a pintle, a fixing member fixedly mounted on the pintle, a rotating member pivotally mounted on the pintle, a fixed cam, and a rotating cam resiliently urged by an elastic device to abut against the fixed cam, and in addition, the fixing member is fixed to a base of the electronic device, and when a cover of the electronic device is rotated with respect to the base, the rotating member that is fixed to the cover causes the rotation of the rotating cam.

Furthermore, the fixed cam and the rotating cam have protuberances and recesses defined thereon and being engagable with each other, namely, on surfaces thereof that are abutted against each other. Accordingly, when the cover is rotated with respect to the base the fixed cam is adapted to be urged axially along the pintle by the rotating cam and the interaction therebetween generates torque that can retain the relative position between the cover and the base and that is variable.

While the torque is variable in response to the axial engaging movement of the fixed cam with respect to the rotating cam that is a consequence of the selective engagement of the protuberances in the corresponding recesses, the interaction of the fixed cam and the rotating cam can not cause many changes in the torque since there is a limited space available to design protuberances and the recesses. In this regard, in order to accomplish many changes in the torque, the design of the protuberances and the recesses would become very complex, and in order not to increase the fixed cam and the rotating cam in their diametrical length so as to keep the hinge small in size, the protuberances and the recesses would be designed with smaller sizes, however, this makes the protuberances and the recesses liable to suffer high wear rate and to fail to allow changes in the torque.

U.S. Pat. Nos. 6,175,990, 7,251,129, 7,187,539 are the examples.

The present invention is, therefore, intended to obviate or at least alleviate the problems encountered in the prior art.

### SUMMARY OF THE INVENTION

According to the present invention, a hinge includes a fixing frame, a cam, a rotating frame, and a torque assembly. The fixing frame includes a compartment extending along a first axis, and an orifice extending along a second axis, and the compartment communicates with the orifice, and in addition, the first axis transverse to the second axis. The cam is insertably mounted to the fixing frame through the orifice. Furthermore, the cam is pivotal about the second axis and includes a cam member of a non-circular cross section and disposed in the compartment. The rotating frame is joined to the cam and rotated with the cam concurrently. The torque assembly is disposed in the compartment and is moveably urged relative to the fixing frame by the cam along the first axis. Furthermore, the torque assembly includes an end abutted against the cam member and another end supported by the fixing frame. Moreover, the torque assembly imposes torque that is variable during the pivoting of the rotating frame with respect to the fixing frame.

It is an object of the present invention to provide a hinge that is capable of generating a torque that is variable.

It is another object of the present invention to provide a hinge that resolves the problem of the conventional hinges.

It is a further object of the present invention to provide a hinge that has a simple structure.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a hinge in accordance with the present invention.

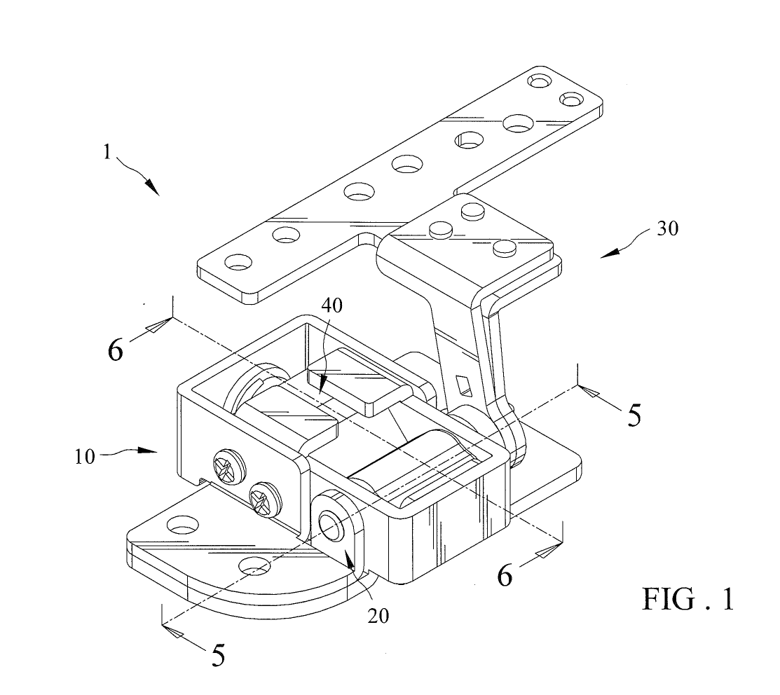

FIG. 2 is an exploded perspective view of the hinge shown in FIG. 1.

FIG. 3 is another exploded perspective view of the hinge shown in FIG. 1.

FIG. 4 is a partial, perspective view of the hinge shown in FIG. 1.

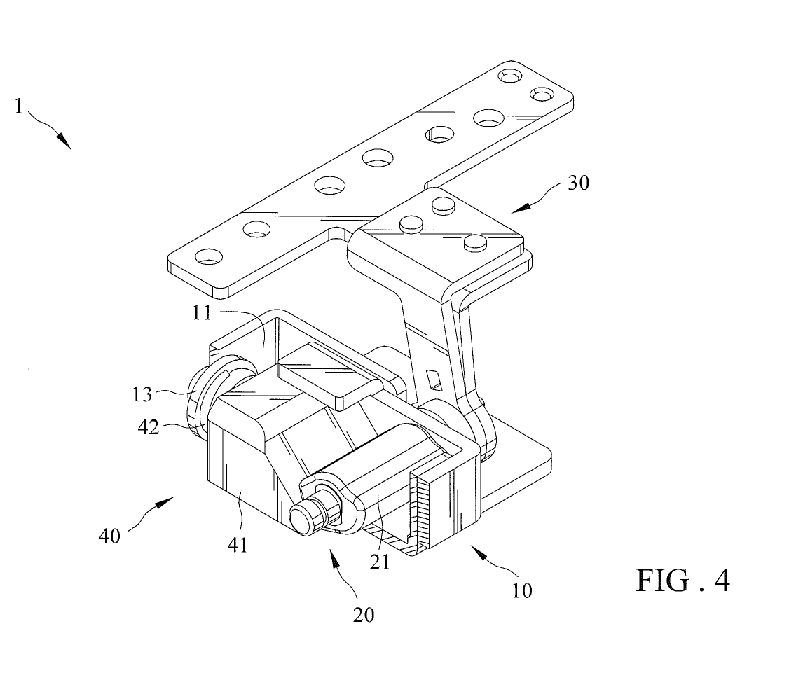

FIG. 5 is a cross-sectional view taken along line 5-5 of FIG. 1.

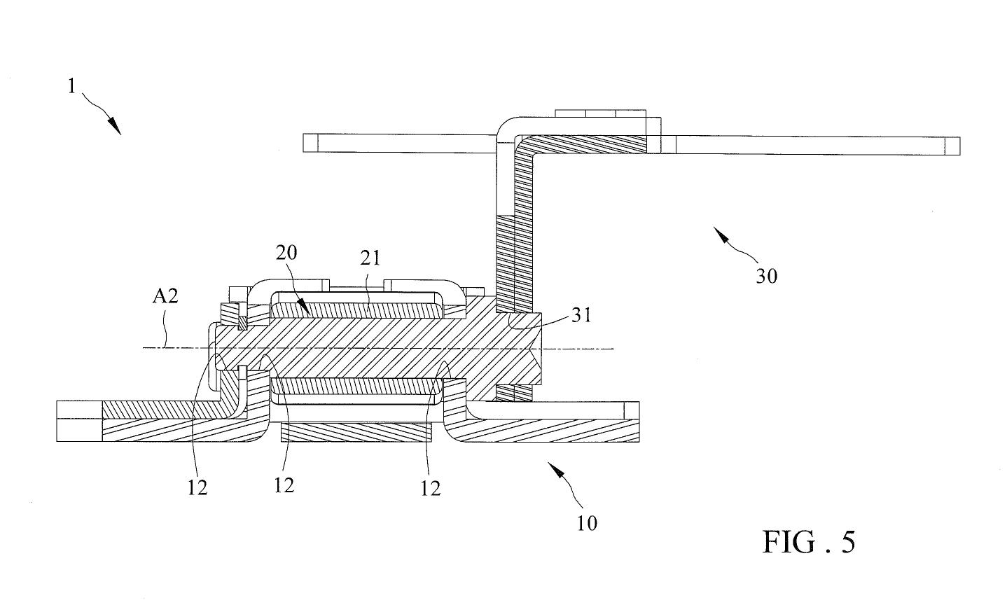

FIG. 6 is a cross-sectional view taken along line 6-6 of FIG. 1 and shows fixing frame and rotating frame of the hinge in a zero-degree position.

FIG. 7 is an extended cross-sectional view of FIG. 6 and shows the rotating frame rotated with respect to the fixing frame.

FIG. 8 is an extended cross-sectional view of FIG. 7 and shows the rotating frame rotated to a different position to that in FIG. 7 with respect to the fixing frame.

FIG. 9 is an extended cross-sectional view of FIG. 8 and shows the rotating frame rotated to a different position to that in FIG. 8 with respect to the fixing frame.

FIG. 10 is an extended cross-sectional view of FIG. 9 and shows the rotating frame rotated to a different position to that in FIG. 9 with respect to the fixing frame.

### DETAILED DESCRIPTION OF THE PREFERRED EMBODIMENT

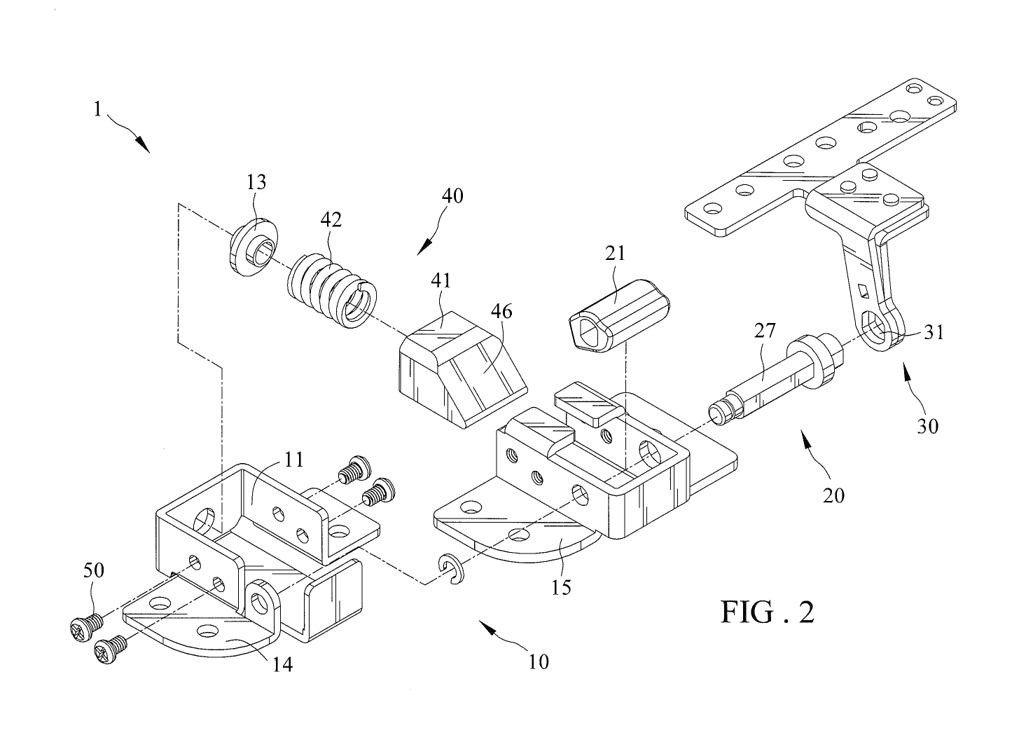

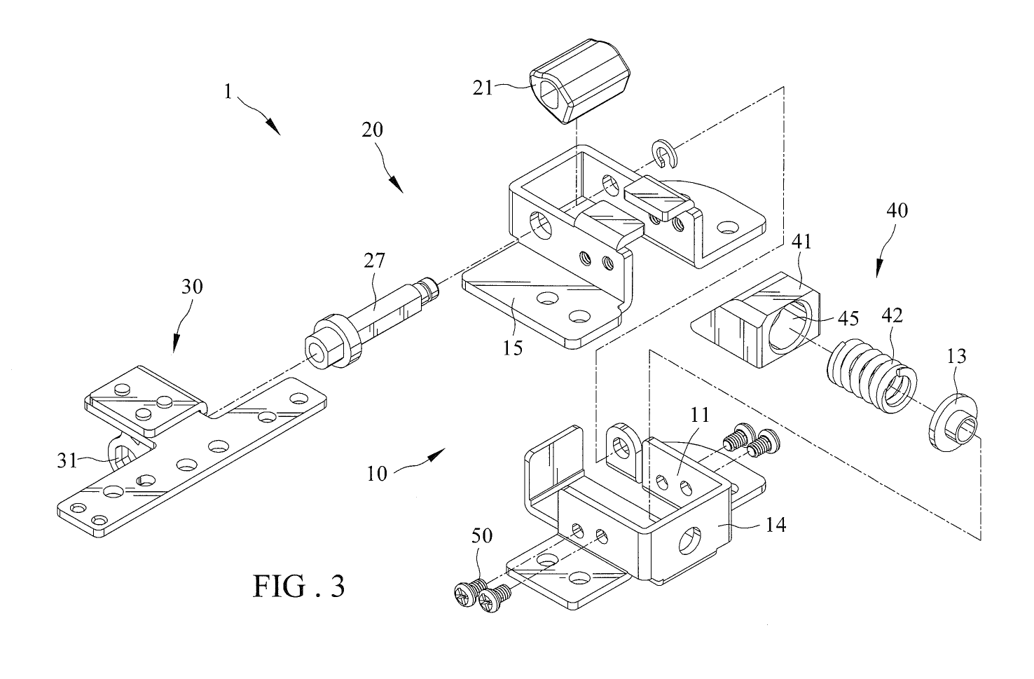

A hinge 1 in accordance with the present invention includes a fixing frame 10, a cam 20, a rotating frame 30, and a torque assembly 40. The hinge 1 is usable in an electronic device which has a cover and a base, that is, the cover is pivotally mounted to the base with the hinge 1. The fixing frame 10 includes a compartment 11 extending along an axis “A1”, and an orifice 12 extending along an axis “A2”. The compartment 11 communicates with the orifice 12. The axis “A1” is transverse to the axis “A2”. In the electronic device employing the hinge 1, the fixing frame 11 is preferably mounted on the base of the electronic device. Additionally, as shown in FIGS. 2 and 3, the fixing frame 10 includes a first fixing frame body 14 and a second fixing frame body 15 of different constructions, and the first and second fixing frame bodies 14 and 15 are joined together by engaging at least one fastener 50 through a lateral wall of the first fixing frame body 14 and a lateral wall of the second fixing frame body 15 and such that the compartment 11 is delimited by lateral walls of the first and second fixing frame bodies 14 and 15. The cam 20 is insertably mounted to the fixing frame 10 through the orifice 12 and is pivotal about the axis “A2”. Furthermore, the cam 20 includes a cam member 21 of a non-circular cross section and disposed in the compartment 11 of the fixing frame 10. As shown in FIGS. 2 and 3, the cam member 21 is supported on the fixing frame 10 by an axle 27, and the cam member 21 and the axle 27 are formed separately. Notwithstanding, the cam member 21 and the axle 27 may be formed integrally as a one-piece element. The rotating frame 30 is joined to the cam 20 and is rotatable with the cam 20 concurrently, that is, the rotating frame 30 includes an aperture 31 receiving a joining end of the cam 20, and the aperture 31 is of a non-circular cross section that prevents relative rotation of the cam 20 and the rotating frame 30. In the electronic device employing the hinge 1, the rotating frame 30 is preferably mounted on the cover of the electronic device. The torque assembly 40 is disposed in the compartment 11 of the fixing frame 10 with one end abutted against the cam 20 and another end abutted against the fixing frame 10 and is moveably urged relative to the fixing frame 10 by the cam 20 along the axis “A1”, that is, the torque assembly 40 includes a block 41 including a first end defining an engaging end 43 that abuts against the cam member 21 of the cam 20 and a second end defining a connecting end 44, and a resilient member 42 including a first end engaged with the connecting end 44 of the block 41 and a second end supported by the fixing frame 10. The block 41 is therefore resiliently urged by the resilient member 42 to interact with the cam member 21 of the cam 20, and the resilient member 42 is deformed along the axis “A1” as the block 41 is moved along the axis “A1”, and in addition, since the cam member 21 is of a non-circular cross section where it includes a periphery defining a first urging surface 22, a second urging surface 23, a third urging surface 24, a first corner 25 extending between the first and second urging surfaces 22 and 23, and a second corner 26 extending between the second and third urging surfaces 23 and 24 that have different radii with respect to the axis “A2”, respectively, force “F” generated by the interaction of the torque assembly 40 and the cam 20, i.e., the block 41 and the cam member 21, imposes variable torque during the pivoting of the rotating member 30. Additionally, in order to make the resilient member 42 retained in a stable engagement with the block 41 during the deformation thereof, the connecting end 44 includes a cavity 45 defined therein receiving the first end of the resilient member 42 and the fixing frame 10 includes a seat 13 mounted thereon engaging with the second end of the resilient member 42.

Furthermore, the engaging end 43 of the block 41 is slopped and defines a slopping surface 46. Additionally, the periphery of the cam member 21 has a gradually increased radius with respect to the axis “A2” from the first urging surface 22 to the first corner 25 thereof, and a gradually reduced radius with respect to the axis “A2” from the first corner 25 to the second corner 26 thereof, and a gradually increased radius with respect to the axis “A2” from the second corner 26 to the third urging surface 24 thereof, and in addition, the first corner 25 measures a radius “D1” with respect to the axis “A2” and the second corner 26 measures a radius “D2 with respect to the axis “A2”, respectively. The radius “D2” is smaller than the radius “D1”.

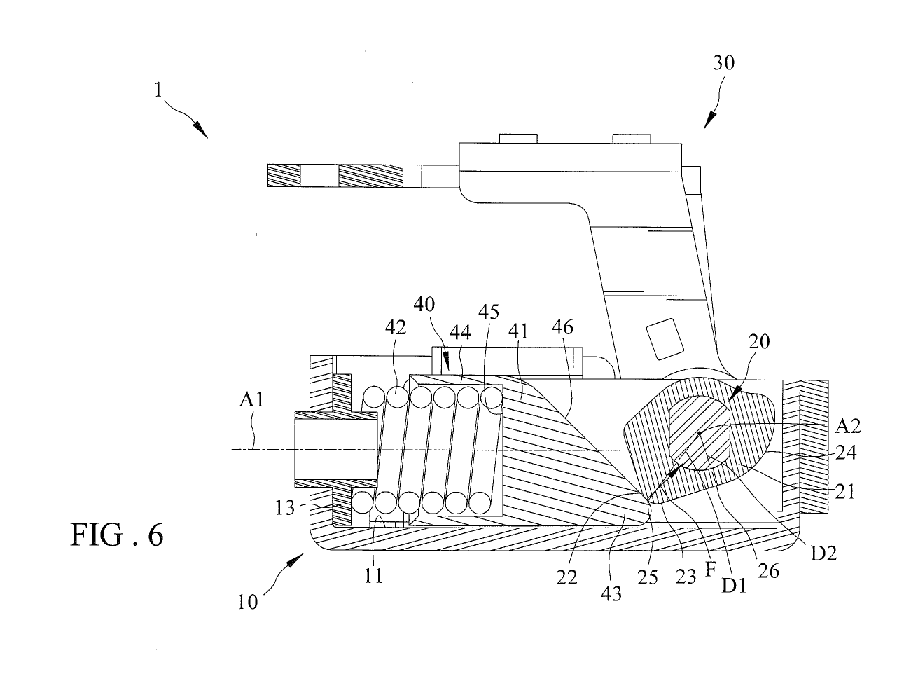

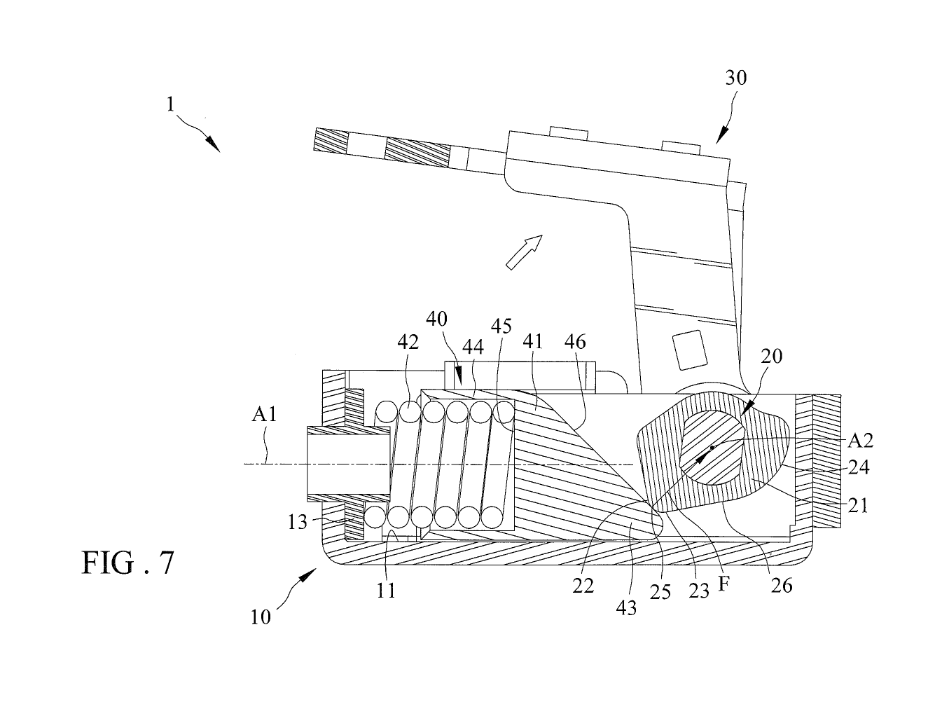

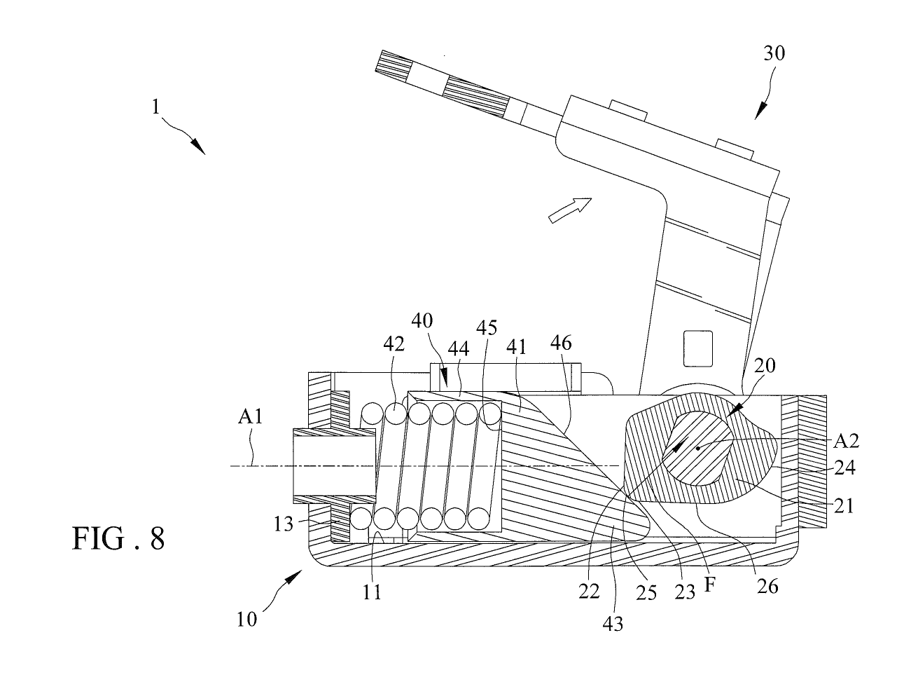

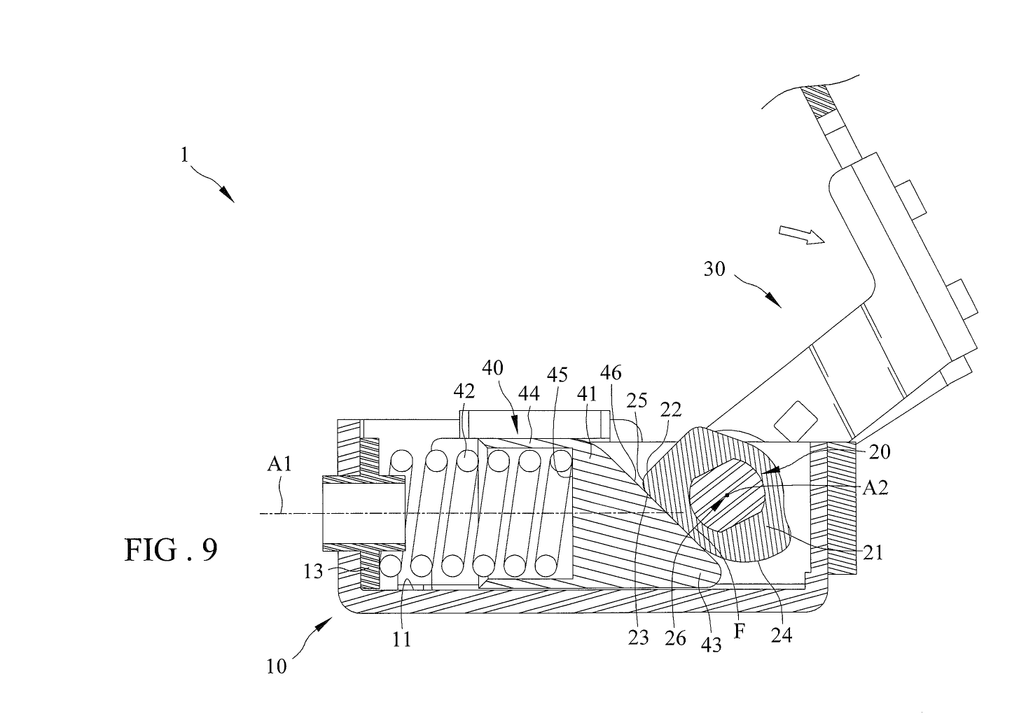

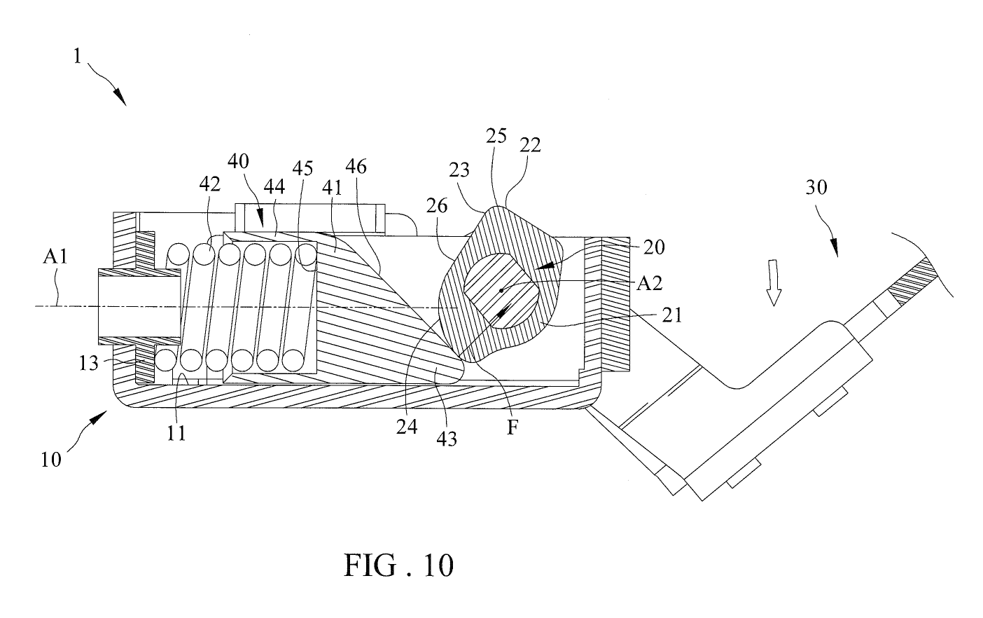

FIG. 6 shows that the fixing frame 10 and the rotating frame 30 are in a zero-degree position where the rotating frame 10 is 0 degree away from fixing frame 10. In this regard, the hinge 1 makes the electronic device in a position that the cover is in a closed position where the base is completely covered by the cover. FIG. 6 also shows that the first urging surface 22 of the cam member 21 is abutted against the slopping surface 46 and the force “F” generated by the interaction of the torque assembly 40 and the cam 20 imposes torque that counteracts the operation of the rotating frame 30 to pivot away from the fixing frame 10, therefore the cover is prevented from being opened until the torque is overcome. Also, when the rotating frame 30 is pivoted substantially through 10 degrees away from the fixing frame 10 from the position shown in FIG. 6 to that shown in FIG. 7, the torque assembly 40 is gradually disengaged from the first urging surface 22 to engage with the first corner 25. Furthermore, FIG. 7 shows the force “F” generated by the torque assembly 40 and the cam 20 does not impose torque. Additionally, when the rotating frame 30 is pivoted substantially through 10 degrees away from the fixing frame 10 from the position shown in FIG. 7 to that shown in FIG. 8, the torque assembly 40 is gradually disengaged from the first corner 25 to engage with the second urging surface 23 and the force “F” generated by the torque assembly 40 and the cam 20 imposes torque that facilitates the pivoting of the rotating frame 30 away from the fixing frame 10, therefore, the cover is adapted to be opened easily to pivot away from the base. As shown in FIG. 9, the rotating frame 30 is adapted to be easily pivoted away from the fixing frame 10 until the rotating frame 30 is pivoted substantially through 70 degree away from the fixing frame 10 and the torque assembly 40 is engaged with second corner 26. Furthermore, FIG. 9 shows that the force “F” generated by the torque assembly and the cam 20 does not impose torque, as the force “F” is deficient of a lever arm with respect to the axis “A2”, and in addition, a flat surface defined by the second urging surface 23 mutually contacts with the slopping surface 46 of the block 41 of the torque assembly 40 to prevent the rotating frame 30 from being inadvertently pivoted away from the fixing frame 10, therefore, the cover can be securely retained at this position relative to the base so it will not wobble and fall. Moreover, when the rotating frame 30 is pivoted further away from the fixing frame 10 from the position shown in FIG. 9 to that shown in FIG. 10, i.e., the rotating frame 30 is pivoted substantially through 140 degrees away from the fixing frame 10, the torque assembly 40 is gradually disengaged from the second corner 26 to engage with the third urging surface 24 and the force “F” generated by the interaction of the torque assembly 40 and the cam 20 imposes increased torque that increases because of the increased radius with respect to the axis “A2” from the second corner 26 to the third urging surface 24, and the torque counteracts the operation of the rotating frame 30 to pivot away from the fixing frame 10, therefore the cover is adapted to be securely retained and is prevented from wobbling and falling. On the contrast, when the rotating frame 30 is pivoted towards the fixing frame 10 from the position shown in FIG. 10 to that shown in FIG. 9, the torque facilitates the pivoting, and when the rotating frame 30 is pivoted towards the fixing frame 10 from the position shown in FIG. 9 to that shown in FIG. 7, the torque counteracts the pivoting so as to prevent the cover from being slammed on the base, and in addition, the rotating frame 30 can be pivoted towards the fixing position from the position shown in FIG. 7 to that shown in FIG. 6 automatically so as to enable the cover to close the base automatically.

In view of the forgoing, the engaging end 43 of the block 41 of the torque assembly 40 is slopped such that the block 41 is adapted to have a reduced thickness. Accordingly, the fixing frame 10 is adapted to be made in a smaller size. Additionally, the hinge 1 is capable of generating torque that is variable and is usable in an electronic device.

While the specific embodiment has been illustrated and described, numerous modifications come to mind without significantly departing from the spirit of invention, and the scope of invention is only limited by the scope of the accompanying claims.

What is claimed is:

1. A hinge, comprising:
a fixing frame including a compartment extending along a first axis, and an orifice extending along a second axis, with the compartment communicating with the orifice, with the first axis transverse to the second axis;
a cam insertably mounted to the fixing frame through the orifice and being pivotal about the second axis, the cam including a cam member of a non-circular cross section and disposed in the compartment;
a rotating frame joined to the cam and rotated with the cam concurrently; and
a torque assembly disposed in the compartment and moveably urged relative to the fixing frame by the cam along the first axis, the torque assembly including an end abutted against the cam member and another end supported by the fixing frame; and
wherein the torque assembly imposes torque that is variable during the pivoting of the rotating frame with respect to the fixing frame.

2. The hinge as claimed in claim 1, wherein the hinge is useable in an electronic device, with the electronic device including a cover and base, with the cover pivotally mounted to the base by the hinge.

3. The hinge as claimed in claim 2, wherein the fixing frame is mounted on the base.

4. The hinge as claimed in claim 2, wherein the rotating frame is mounted on the cover.

5. The hinge as claimed in claim 1, wherein the fixing frame includes a first fixing frame body and a second fixing frame body of different constructions, with the first fixing frame body joined to the second fixing frame body, with the compartment delimited by lateral walls of the first and second fixing frame body.

6. The hinge as claimed in claim 5, wherein the first and second fixing frame bodies are joined together by engaging at least one fastener through a lateral wall of the first fixing frame body and a lateral wall of the second fixing frame body.

7. The hinge as claimed in claim 1, wherein the torque assembly includes a block including a first end defining an engaging end abutting against the cam member and a second end defining a connecting end, and a resilient member resiliently urging the block and including a first end engaged with the connecting end and a second supported by the fixing frame.

8. The hinge as claimed in claim 7, wherein the resilient member is deformed along the first axis.

9. The hinge as claimed in claim 1, wherein the cam member includes a periphery defining a first urging surface, a second urging surface, a third urging surface, a first corner extending between the first and second urging surfaces, and a second corner extending between the second and third urging surfaces that have different radii with respect to the second axis, respectively, with interaction of the first corner and the cam member as well as interaction of the second corner and the cam member imposing no torque.

10. The hinge as claimed in claim 9, wherein the cam member has a gradually increased radius with respect to the second axis from the first urging surface to the first corner thereof, and a gradually reduced radius with respect to the second axis from the first corner to the second corner thereof, and a gradually increased radius with respect to the second axis from the second corner to the third urging surface thereof.

11. The hinge as claimed in claim 9, wherein the first corner 25 measures a first radius with respect to the second axis and the second corner measures a second radius with respect to the second axis, respectively, with the second radius smaller than the first radius.

12. The hinge as claimed in claim 7, wherein the connecting end includes a cavity defined therein receiving the first end of the resilient member and the fixing frame includes a seat mounted thereon engaging with the second end of the resilient member.

13. The hinge as claimed in claim 7, wherein the engaging end is slopped and defines a slopping surface.

14. The hinge as claimed in claim 10, wherein the engaging end is slopped and defines a slopping surface.

15. The hinge as claimed in claim 14, wherein the second urging surface defines a flat surface mutually contacting with the slopping surface.
